(19) United States
(12) Patent Application Publication
(10) Pub. No.: US 2019/0372155 A1
(43) Pub. Date: Dec. 5, 2019

(54) METHODS OF MANUFACTURING HIGH-ACTIVE-MATERIAL-LOADING COMPOSITE ELECTRODES AND ALL-SOLID-STATE BATTERIES INCLUDING COMPOSITE ELECTRODES

(71) Applicant: GM GLOBAL TECHNOLOGY OPERATIONS LLC, Detroit, MI (US)

(72) Inventors: Thomas A. YERSAK, Ferndale, MI (US); James R. SALVADOR, Royal Oak, MI (US); Robert D. SCHMIDT, Royal Oak, MI (US)

(73) Assignee: GM GLOBAL TECHNOLOGY OPERATIONS LLC, Detroit, MI (US)

(21) Appl. No.: 15/992,878

(22) Filed: May 30, 2018

(51) Int. Cl. H01M 10/0562; H01M 10/0585; H01M 10/0525; H01M 4/62; H01M 4/139; H01M 4/38; H01M 10/0566; H01M 10/0565

(52) U.S. Cl. CPC H01M 10/0562; H01M 10/0585; H01M 10/0525; H01M 4/62; H01M 4/139; H01M 2300/0082; H01M 10/0566; H01M 10/0565; H01M 2300/0091; H01M 2300/0068; H01M 4/382

(57) ABSTRACT

A method of fabricating a composite electrode for use in an electrochemical cell includes preparing a layer of powder including a plurality of electroactive material particles and a plurality of electrolyte particles. The electrolyte particles include a sulfide or oxy-sulfide glass. The method further includes heating the layer of powder to a temperature of greater than or equal to T_{g} and less than T_{c}. T_{g} is a glass transition temperature of the sulfide or oxy-sulfide glass. T_{c} is a crystallization temperature of the sulfide or oxy-sulfide glass. The method further includes, while the sulfide or oxy-sulfide glass electrolyte is at the temperature, applying a pressure of about 0.1-360 MPa to the layer of powder. The pressure causes the sulfide or oxy-sulfide glass to flow around the electroactive material particles to create a compact. The present disclosure also provides methods of creating laminates including the composite electrodes.

The present disclosure relates to methods of manufacturing high-active-material-loading composite electrodes and high-energy-density all-solid-state batteries including composite electrodes, and more particularly composite electrodes containing sulfide or oxy-sulfide glasses.

This section provides background information related to the present disclosure which is not necessarily prior art.

High-energy density, electrochemical cells, such as lithium-ion and lithium-metal batteries can be used in a variety of consumer products and vehicles, such as Hybrid Electric Vehicles (HEVs) and Electric Vehicles (EVs). All-solid-state batteries include a solid-state electrolyte (SSE) disposed between a positive electrode and a negative electrode. The solid-state electrolyte can enable the transport of metal ions (e.g., lithium or sodium ions) between the negative electrode and the positive electrode while also physically separating the positive and negative electrodes. All-solid-state batteries offer several advantages, such as long shelf life with zero self-discharge, operation without thermal management systems, and a reduced need for packaging.

### SUMMARY

This section provides a general summary of the disclosure, and is not a comprehensive disclosure of its full scope or all of its features.

In various aspects, the present disclosure provides a method of fabricating a composite electrode for use in an electrochemical cell. The method includes preparing a layer of powder. The layer of powder includes a plurality of electroactive material particles and a plurality of electrolyte particles. The electrolyte particles include a sulfide or oxy-sulfide glass. The method further includes heating the layer of powder to a temperature of greater than or equal to T_{g} and less than T_{c}. T_{g} is a glass transition temperature of the sulfide or oxy-sulfide glass. T_{c} is a crystallization temperature of the sulfide or oxy-sulfide glass. The method further includes, while the sulfide or oxy-sulfide glass electrolyte is at the temperature, applying a pressure of about 0.1-360 MPa to the layer of powder. The pressure causes the sulfide or oxy-sulfide glass to flow around the electroactive material particles to create a compact.

In one aspect, the pressure is about 0.1-10 MPa.

In one aspect, the pressure is applied for about 1-3,600 seconds.

In one aspect, the compact has a porosity of ≤5%.

In one aspect, the layer of powder further incorporates at least one of (i) a plurality of electrically-conductive particles and (ii) a reinforcement. The reinforcement is in a form of: a plurality of individual chopped fibers, a non-woven fiber mat, a woven fiber mat, or a plurality of particles with a plate-like geometry.

In one aspect, the method further includes powderizing the compact to create plurality of electrolyte-coated electroactive material particles. The method further includes film casting an admixture comprising the plurality of electrolyte-coated electroactive material particles to form the composite electrode.

In other aspects, the present disclosure provides a method of fabricating an electrode-separator laminate for an electrochemical cell. The method includes fabricating a pre-laminate. A pre-laminate is fabricated by placing a composite electrode composition and a separator composition in direct physical contact. The composite electrode composition includes an electroactive material and an electrolyte. The electrolyte includes a sulfide or oxy-sulfide glass. The separator composition includes an electrolyte. The electrolyte includes another sulfide or oxy-sulfide glass. The separator is ionically conductive and electrically insulating. The method further includes heating the pre-laminate to a temperature of greater than or equal to T_{g} and less than T_{c}. T_{g} is a highest glass transition temperature of the sulfide or oxy-sulfide glasses. T_{c} is a lowest crystallization temperature of the sulfide or oxy-sulfide glasses. The method further includes applying pressure to compress the pre-laminate. The pressure is about 0.1-360 MPa.

In one aspect, the pressure is applied for about 1-3,600 seconds.

In one aspect, the separator composition includes a different sulfide or oxy-sulfide glass than the composite electrode composition.

In one aspect, the forming the pre-laminate further includes placing the separator composition in direct physical contact with another composite electrode composition such that the separator composition is disposed between the composite electrode compositions. One of the composite electrode compositions includes a positive electroactive material. The other of the composite electrode compositions includes a negative electroactive material.

In one aspect, the method further includes, after the heating the pre-laminate, placing a lithium-metal electrode in communication with the separator composition to form an intermediate-laminate such that the separator composition is disposed between the composite electrode composition and the lithium-metal electrode. The method further includes applying pressure to compress the intermediate-laminate. The pressure is about 0.1-360 MPa.

In one aspect, the applying pressure to compress the intermediate-laminate is performed at a temperature of about 0-180° C.

In one aspect, the method further includes after the heating the pre-laminate, disposing another electrolyte between the separator composition and a lithium-metal electrode. The other electrolyte includes a liquid electrolyte, a gel electrolyte, or a polymer electrolyte.

In yet other aspects, the present disclosure provides a composite electrode for use in an electrochemical cell. The composite electrode includes an electroactive material and a solid electrolyte. The solid electrolyte includes a sulfide or oxy-sulfide glass. A mass percentage of electroactive material in the composite electrode is ≥50%. The composite electrode has a porosity of ≤5%.

In one aspect, the electroactive material is in a form of a plurality of particles. Each particle has an outermost surface area that is at least 75% coated by the solid electrolyte.

In one aspect, the composite electrode further includes an electrically-conductive particle.

In one aspect, the composite electrode further includes a reinforcement. The reinforcement is in a form of a plurality of individual chopped fibers, a non-woven fiber mat, a woven fiber mat, or a plurality of particles with a plate-like geometry. The reinforcement is selected from the group consisting of: a silica-based glass fiber, an alumina fiber, a boron nitride fiber, an exfoliated clay particle, a mineral particle, a thermoplastic polymer fiber, a carbon fiber, a conductive polymer fiber, a metal fiber, and combinations thereof.

In one aspect, the electroactive material is a positive electroactive material and the mass percentage is ≥65%.

In one aspect, the electroactive material is a negative electroactive material and the mass percentage is ≥55%.

In one aspect, the porosity is ≤3%.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of an exemplary electrochemical battery cell;

FIG. 2 is an illustration of a continuous process for forming a composite electrode including a sulfide or oxy-sulfide glass electrolyte and an electroactive material according to certain aspects of the present disclosure;

FIG. 3 is a composite electrode including an electroactive material, a sulfide or oxy-sulfide glass, a conductive particle, and a reinforcement according to certain aspects of the present disclosure;

FIG. 4 is a flowchart illustrating a method of making a laminate for a lithium-ion battery according to certain aspects of the present disclosure, the laminate including a composite positive electrode, a composite negative electrode, and a solid-state-electrolyte, each including a sulfide or oxy-sulfide glass;

FIG. 5 is a laminate for a lithium-ion battery formed by the method of FIG. 4;

FIG. 6 is a flowchart illustrating a method of making a laminate for a lithium-metal battery according to certain aspects of the present disclosure, the laminate including a composite positive electrode and a solid-state electrolyte that each include a sulfide or oxy-sulfide glass, and a negative electrode that includes lithium metal;

FIG. 7 is a laminate for a lithium-metal battery formed by the method of FIG. 6; and

FIG. 8 is a scanning electron microscope (SEM) image of a compact formed according to certain aspects of the present disclosure, the compact including carbon fiber and a sulfide or oxy-sulfide glass electrolyte.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

### General Structure and Function of Electrochemical Cells

Typical electrochemical cells or batteries include two electrodes, an electrolyte material, and a separator. One electrode serves as a positive electrode or cathode and another serves as a negative electrode or anode. A stack of battery cells may be electrically connected to increase overall output. Conventional rechargeable lithium-ion batteries operate by reversibly passing lithium ions back and forth between the negative electrode and the positive electrode. The separator and electrolyte are disposed between the negative and positive electrodes. The electrolyte is suitable for conducting lithium ions and may be in solid or liquid form. Lithium ions move from the positive electrode to the negative electrode during charging of the battery and in the opposite direction when discharging the battery.

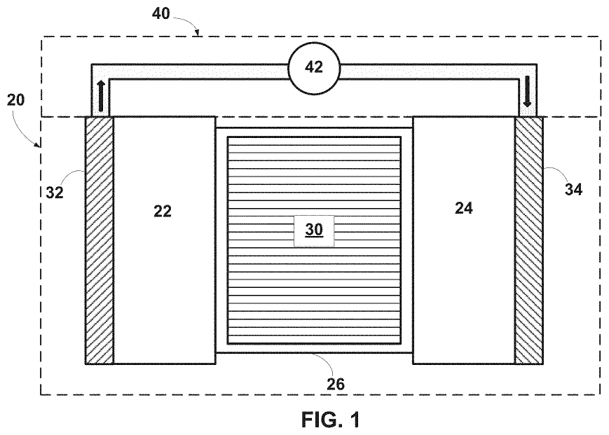

An exemplary and schematic illustration of an electrochemical cell 20 (also referred to as the battery) that cycles lithium ions is shown in FIG. 1. The battery 20 includes a negative electrode 22, a positive electrode 24, and a porous separator 26 (e.g., a microporous or nanoporous polymeric separator) disposed between the two electrodes 22, 24. The porous separator 26 includes an electrolyte 30, which may also be present in the negative electrode 22 and the positive electrode 24. A negative electrode current collector 32 may be positioned at or near the negative electrode 22 and a positive electrode current collector 34 may be positioned at or near the positive electrode 24. The negative electrode current collector 32 and the positive electrode current collector 34 respectively collect and move free electrons to and from an external circuit 40. An interruptible external circuit 40 and load device 42 connect the negative electrode 22 (through the negative electrode current collector 32) and the positive electrode 24 (through the positive electrode current collector 34).

The porous separator 26 operates as both an electrical insulator and a mechanical support. The porous separator 26 is located by being “sandwiched” between the negative electrode 22 and the positive electrode 24 so as to prevent physical contact between the electrodes 22, 24 and thus, the occurrence of a short circuit. The porous separator 26, in addition to providing a physical barrier between the two electrodes 22, 24, can provide a minimal resistance path for internal passage of lithium ions (and related anions) during cycling of the lithium ions to facilitate functioning of the battery 20.

The battery 20 can generate an electric current during discharge by way of reversible electrochemical reactions that occur when the external circuit 40 is closed (to connect the negative electrode 22 and the positive electrode 24) when the negative electrode 22 contains a relatively greater quantity of lithium. The chemical potential difference between the positive electrode 24 and the negative electrode 22 drives electrons produced at the negative electrode 22 through the external circuit 40 toward the positive electrode 24. Lithium ions, which are also produced at the negative electrode 22, are concurrently transferred through the electrolyte 30 and porous separator 26 towards the positive electrode 24. The electrons flow through the external circuit 40 and the lithium ions migrate across the porous separator 26 in the electrolyte 30 to the positive electrode 24, where they may be plated, reacted, or intercalated. The electric current passing through the external circuit 40 can be harnessed and directed through the load device 42 until the lithium in the negative electrode 22 is depleted and the capacity of the battery 20 is diminished. While in lithium-ion batteries, lithium intercalates and/or alloys in the electroactive materials. In a lithium-sulfur battery, instead of intercalating or alloying, the lithium dissolves from the negative electrode and migrates to the positive electrode where it reacts/plates during discharge, while during charging, lithium plates on the negative electrode.

The battery 20 can be charged or re-energized at any time by connecting an external power source to the battery 20 to reverse the electrochemical reactions that occur during battery discharge. The connection of the external power source to the battery 20 compels the production of electrons and release of lithium ions from the positive electrode 24. The electrons, which flow back towards the negative electrode 22 through the external circuit 40, and the lithium ions, which are carried by the electrolyte 30 across the separator 26 back towards the negative electrode 22, reunite at the negative electrode 22 and replenish it with lithium for consumption during the next battery discharge cycle. As such, each discharge and charge event is considered to be a cycle, where lithium ions are cycled between the positive electrode 24 and negative electrode 22.

The external power source that may be used to charge the battery 20 may vary depending on the size, construction, and particular end-use of the battery 20. Some notable and exemplary external power sources include an AC wall outlet and a motor vehicle alternator. In many lithium-ion battery configurations, each of the negative current collector 32, the negative electrode 22, the separator 26, the positive electrode 24, and the positive current collector 34 are prepared as relatively thin layers (e.g., from several microns to a millimeter or less in thickness) and assembled in layers connected in electrical parallel arrangement to provide a suitable electrical energy and power package.

Furthermore, the battery 20 can include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26, by way of example. As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42.

Accordingly, the battery 20 can generate electric current to a load device 42 that can be operatively connected to the external circuit 40. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of example. The load device 42 may also be a power-generating apparatus that charges the battery 20 for purposes of storing energy. In certain other variations, the electrochemical cell may be a supercapacitor, such as a lithium-ion based supercapacitor.

### i. Separator

With renewed reference to FIG. 1, the porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin is polyethylene (PE), polypropylene (PP), blend of PE and PP, or multi-layered structured porous films of PE and/or PP. Commercially available polyolefin porous membranes include CELGARD® 2500 (a monolayer polypropylene separator) and CELGARD® 2320 (a trilayer polypropylene/polyethylene/polypropylene separator) available from Celgard LLC.

The porous separator 26 may be a single layer or a multi-layer laminate when it is a microporous polymeric separator, and may be fabricated from either a dry process or wet process. For example, in one embodiment, a single layer of the polyolefin may form the entire microporous polymer separator 26. In other aspects, the separator 26 may be a fibrous membrane having an abundance of pores extending between the opposing surfaces and may have a thickness of less than a millimeter, for example. As another example, however, multiple discrete layers of similar or dissimilar polyolefins may be assembled to form the microporous polymer separator 26. Furthermore, the porous separator 26 may be mixed with a ceramic material or its surface may be coated in a ceramic material. For example, a ceramic coating may include alumina (Al₂O₃), silicon dioxide (SiO₂), or combinations thereof. Various conventionally available polymers and commercial products for forming the separator 26 are contemplated, as well as the many manufacturing methods that may be employed to produce such a microporous polymer separator 26.

### ii. Positive Electrode

The positive electrode 24 may be formed from a lithium-based active material that can undergo lithium intercalation and deintercalation, alloying and dealloying, or plating and stripping, while functioning as the positive terminal of the battery 20. The positive electrode 24 electroactive materials may include one or more transition metals, such as manganese (Mn), nickel (Ni), cobalt (Co), chromium (Cr), iron (Fe), vanadium (V), and combinations thereof. Two exemplary common classes of known electroactive materials that can be used to form the positive electrode 24 are lithium transition metal oxides with layered structures and lithium transition metal oxides with spinel phase. For example, in certain instances, the positive electrode 24 may include a spinel-type transition metal oxide, like lithium manganese oxide (Li₍₁₊ₓ₎Mn₍₂₋ₓ₎O₄), where x is typically <0.15, including LiMn₂O₄ (LMO) and lithium manganese nickel oxide LiMn_{1.5}Ni_{0.5}O₄ (LMNO). In other instances, the positive electrode 24 may include layered materials like lithium cobalt oxide (LiCoO₂), lithium nickel oxide (LiNiO₂), a lithium nickel manganese cobalt oxide (Li(NiₓMn_{y}Co_{z})O₂), where 0≤x≤1, 0≤y≤1, 0≤z≤1, and x+y+z=1, including LiMn_{0.33}Ni_{0.33}Co_{0.33}O₂, a lithium nickel cobalt metal oxide (LiNi_{(1-x-y)}CoₓM_{y}O₂), where 0<x<1, 0<y<1 and M may be Al, Mn, or the like. Other known lithium-transition metal compounds such as lithium iron phosphate (LiFePO₄) or lithium iron fluorophosphate (Li₂FePO₄F) can also be used. In certain aspects, the positive electrode 24 may include an electroactive material that includes manganese, such as lithium manganese oxide (Li₍₁₊ₓ₎Mn₍₂₋ₓ₎O₄), a mixed lithium manganese nickel oxide (LiMn₍₂₋ₓ₎NiₓO₄), where 0≤x≤1, and/or a lithium manganese nickel cobalt oxide (e.g., LiMn_{0.33}Ni_{0.33}Co_{0.33}O₂). In a lithium-sulfur battery, positive electrodes may have elemental sulfur as the active material or a sulfur-containing active material.

In certain variations, such active materials are intermingled with an optional electrically conductive material and/or at least one polymeric binder material. The binder material may structurally fortify the lithium-based active material. For example, the active materials and optional conductive materials may be slurry cast with such binders, like polyvinylidene difluoride (PVdF), ethylene propylene diene monomer (EPDM) rubber, or carboxymethoxyl cellulose (CMC), a nitrile butadiene rubber (NBR), lithium polyacrylate (LiPAA), sodium polyacrylate (NaPAA), sodium alginate, and lithium alginate. Electrically conductive materials may include graphite, carbon-based materials, powdered nickel, metal particles, or a conductive polymer. Carbon-based materials may include particles of: KETCHEN™ black, DENKA™ black, acetylene black, carbon black, and the like. Examples of a conductive polymer include polyaniline, polythiophene, polyacetylene, polypyrrole, and the like. In certain aspects, mixtures of conductive materials may be used.

### iii. Negative Electrode

The negative electrode 22 may include an electroactive material as a lithium host material capable of functioning as a negative terminal of a lithium-ion battery. Common negative electrode materials include lithium insertion materials or alloy host materials, like carbon-based materials, such as lithium-graphite intercalation compounds, or lithium-silicon compounds, lithium-tin alloys, and lithium titanate Li₄₊ₓTi₅O₁₂, where 0≤x≤3, such as Li₄Ti₅Oi₂ (LTO). Where the negative electrode 22 is made of metallic lithium, the electrochemical cell is considered a lithium-metal battery or cell. Metallic lithium for use in the negative electrode of a rechargeable battery has various potential advantages, including having the highest theoretical capacity and lowest electrochemical potential. Thus, batteries incorporating lithium-metal anodes can have a higher energy density that can potentially double storage capacity, so that the battery may be half the size, but still last the same amount of time as other lithium-ion batteries. Thus, lithium-metal batteries are one of the most promising candidates for high energy storage systems. However, lithium-metal batteries also have potential downsides, including possibly exhibiting unreliable or diminished performance and potential premature electrochemical cell failure.

There are two primary causes for performance degradation with lithium metal negative electrodes. Side reactions can occur between the lithium metal and species in the adjacent electrolyte disposed between the positive and negative electrodes, which can compromise coulombic efficiency and cycling lifetime of rechargeable lithium batteries. Also, when the lithium metal is recharged, branchlike or fiber-like metal structures, called dendrites, can grow on the negative electrode. The metal dendrites may form sharp protrusions that potentially puncture the separator and cause an internal short circuit, which may cause cell self-discharge or cell failure through thermal runaway.

In certain variations, the negative electrode 22 may optionally include an electrically conductive material, as well as one or more polymeric binder materials to structurally hold the lithium material together. Negative electrodes may include about 50-100% of an electroactive material (e.g., lithium particles or a lithium foil), and optionally ≤30% of an electrically conductive material, and a balance binder. For example, in one embodiment, the negative electrode 22 may include an active material including lithium-metal particles intermingled with a binder material selected from the group consisting of: polyvinylidene difluoride (PVdF), ethylene propylene diene monomer (EPDM) rubber, carboxymethoxyl cellulose (CMC), a nitrile butadiene rubber (NBR), lithium polyacrylate (LiPAA), sodium polyacrylate (NaPAA), sodium alginate, lithium alginate, and combinations thereof. Suitable additional electrically conductive materials may include carbon-based material or a conductive polymer. Carbon-based materials may include by way of example, particles of KETCHEN™ black, DENKA™ black, acetylene black, carbon black, and the like. Examples of a conductive polymer include polyaniline, polythiophene, polyacetylene, polypyrrole, and the like. In certain aspects, mixtures of conductive materials may be used.

An electrode may be made by mixing the electroactive material, such as lithium particles, into a slurry with a polymeric binder compound, a non-aqueous solvent, optionally a plasticizer, and optionally if necessary, electrically conductive particles. The slurry can be mixed or agitated, and then thinly applied to a substrate via a doctor blade. The substrate can be a removable substrate or alternatively a functional substrate, such as a current collector (such as a metallic grid or mesh layer) attached to one side of the electrode film. In one variation, heat or radiation can be applied to evaporate the solvent from the electrode film, leaving a solid residue. The electrode film may be further consolidated, where heat and pressure are applied to the film to sinter and calendar it. In other variations, the film may be air-dried at moderate temperature to form self-supporting films. If the substrate is removable, then it is removed from the electrode film that is then further laminated to a current collector. With either type of substrate, it may be necessary to extract or remove the remaining plasticizer prior to incorporation into the battery cell.

In other variations, a negative electrode 22 may be in the form of lithium metal, such as a lithium foil or lithium film. The lithium metal layer may be disposed on the negative current collector 32.

### iv. Optional Electrode Surface Coatings

In certain variations, pre-fabricated electrodes formed of electroactive material via the active material slurry casting described above can be directly coated via a vapor coating formation process to form a conformal inorganic-organic composite surface coating, as described further below. Thus, one or more exposed regions of the pre-fabricated negative electrodes comprising the electroactive material can be coated to minimize or prevent reaction of the electrode materials with components within the electrochemical cell to minimize or prevent lithium metal dendrite formation on the surfaces of negative electrode materials when incorporated into the electrochemical cell. In other variations, a plurality of particles comprising an electroactive material, like lithium metal, can be coated with an inorganic-organic composite surface coating. Then, the coated electroactive particles can be used in the active material slurry to form the negative electrode, as described above.

### v. Current Collectors

The positive current collector 34 may be formed from aluminum or any other appropriate electrically conductive material known to those of skill in the art. The negative electrode current collector 32 may be formed from copper or any other appropriate electrically conductive material known to those of skill in the art. A negative electrode current collector may be a copper collector foil, which may be in the form of an open mesh grid or a thin film.

### vi. Electrolyte Systems

Each of the separator 26, the negative electrode 22, and the positive electrode 24 may include an electrolyte system 30, capable of conducting lithium ions between the negative electrode 22 and the positive electrode 24. In various aspects, the electrolyte system 30 may be a non-aqueous liquid electrolyte solution including a lithium salt and at least one additive compound dissolved in an organic solvent or a mixture of organic solvents. Example organic solvents include ether-based solvents and carbonate-based solvents.

### vii. Packaging

A battery may thus be assembled in a laminated cell structure, including a negative electrode layer, a positive electrode layer, and electrolyte/separator between the anode and cathode layers. The negative electrode layer and the positive electrode layer each include a current collector. The current collector can be connected to an external current collector tab. A protective bagging material covers the cell and prevents infiltration of air and moisture. Into this bag, an electrolyte is injected into the separator (and may also be imbibed into the positive and/or negative electrodes) suitable for lithium ion transport. In certain aspects, the laminated battery is further hermetically sealed prior to use.

### All-Solid-State and Hybrid Batteries

As noted above, there are several benefits to the use of all-solid-state batteries. First, all-solid-state batteries may have long shelf lives with minimal to no self-discharge because many solid-state electrolytes (SSEs) are nearly pure ionic conductors. Next, because SSEs are generally non-volatile and non-flammable, all-solid-state batteries can be cycled under harsher conditions than typical lithium-ion batteries without concern for thermal runaway. Thus, thermal management systems can be eliminated or de-rated. Next, all-solid-state batteries may be resistant to puncture and mechanical abuse, which facilitates a reduction in packing. Finally, all-solid-state batteries may be particularly well-suited to the use of lithium-metal negative electrodes because of the reduced occurrence of dendritic shorting when the battery includes a mechanically-robust SSE. The above benefits may also be realized in the case of a hybrid battery having a positive electrode, a lithium metal negative electrode, an SSE separator disposed between the positive and negative electrodes, and another electrolyte disposed between the SSE separator and the negative electrode. The other electrolyte may be a liquid, gel, or polymer electrolyte.

One type of SSE is formed from sulfide or oxy-sulfide glass. Sulfide and oxy-sulfide glasses are formed by combining: one or more glass formers, one or more glass modifiers, and an optional dopant. The glass former and the glass modifier may be collectively referred to as a glass forming system. In various aspects, when two glass formers are used, they may be referred to as a glass former and a glass co-former. For a sulfide glass, both the glass former and the glass modifier include sulfur. An oxy-sulfide glass can either include (i): an oxide forming system (e.g., an oxide-containing glass former and an oxide-containing glass modifier) with a sulfide co-former; or (ii) a sulfide forming system (e.g., a sulfide-containing glass former and a sulfide-containing glass modifier) with an oxide co-former.

The glass former may include a glass-forming sulfide or oxide. Glass forming sulfides include: P₂S₅, SnS₂, GeS₂, B₂S₃, SiS₂, and combinations thereof, by way of example. Glass-forming oxides include SiO₂, GeO₂, P₂O₅, B₂O₃, Al₂O₃, and combinations thereof, by way of example. The glass modifier can also include a sulfide or oxide. Sulfide-containing glass modifiers include Li₂S, Na₂S, and combinations thereof, by way of example. Oxide-containing glass modifiers include Li₂O, Na₂O, and combinations thereof, by way of example. For use in batteries with lithium-containing negative electrodes, the glass modifier may include lithium (e.g., Li₂S, Li₂O). For use in batteries with sodium-containing negative electrodes, the glass modifier may include sodium (e.g., Na₂S, Na₂O). To support advantageous electrolytic activity, at least one of the glass former and the glass modifier may contain sulfur. The dopant can be used to improve glass formability and/or stability. In various aspects, the dopant includes: LiI, Li₃PO₄, Li₄SiO₄, and combinations thereof.

The constituent precursors—namely, the glass former/s and the glass modifier/s—react to form a sulfide or oxy-sulfide glass that enables the formation of mobile alkali metal cations. For convenience, the sulfide and oxy-sulfide glass compositions detailed herein will be described in terms of the atomic proportions of their glass-forming-system constituents. However, when reacted, the constituent precursors will form glasses having an anchored sulfide and/or oxygen tetrahedral anions with mobile lithium (or sodium) ions. For example, a glass that is formed from 70 mole percent Li₂S glass modifier and 30 mole percent P₂S₅ glass former may be described as 70Li₂S-30P₂S₅, and have composition Li₇P₃S₁₁ when formed. The glass may include anchored phosphorus sulfide tetrahedral anion structural units (PS₄³⁻) and mobile lithium ions (Lit).

Some all-solid-state batteries may have low energy density compared to non-solid-state batteries, such as those having a porous separator with liquid electrolyte. In non-solid-state batteries such as those described above, liquid electrolyte is able to flow into void spaces between electroactive material particles, leading to intimate contact between the electroactive material and the electrolyte. The intimate contact between the electroactive material and the electrolyte facilitates a reduction in amount of electrolyte required, and therefore a higher active material content.

In contrast, composite electrodes for all-solid-state batteries include particles of electroactive material admixed and formed with particles of SSE. The electrodes may be formed by cold pressing, through the use of binders, or through a combination of cold pressing and binders. Electrodes formed by cold pressing or with binders typically have a porosity of about 15%. As a result of the porosity, direct contact between the electroactive particles and the SSE may be much lower than in non-solid-state batteries. Accordingly, all-solid-state batteries often include a much greater quantity of SSE compared to non-solid-state batteries, both within the composite electrode/s and in the separator (resulting in a thick separator). The large quantity of SSE results in a low active material loading, translating to low energy density and power in a battery.

In one example of a lithium-ion all-solid-state battery, a positive electrode has 60% active material loading (i.e., 60% positive electroactive material by weight, with the balance being SSE, conductive additive, and binder), the negative electrode has 40% active material loading (i.e., 40% negative electroactive material by weight, with the balance being SSE, conductive additive, and binder), the electrodes are 15% porous, and the separator is 240 μm thick. The resulting energy density is about 133 Wh/kg. Energy density can be increased by increasing the active material content. One way of increasing the active material content is by reducing a thickness of the separator, thereby decreasing the mass of SSE. In another example of a lithium-ion all-solid-state battery, a positive electrode has 60% active material loading (i.e., 60% positive electroactive material by weight, with the balance being SSE), a negative electrode has 40% active material loading (i.e., 40% negative electroactive material by weight, with the balance being SSE), the electrodes are 15% porous, and a separator is reduced to 30 μm thick. The resulting energy density is 170 Wh/kg.

Another way to increase energy density is to use a lithium-metal electrode, rather than a composite negative electrode. Lithium-metal electrodes are often thinner than composite electrodes and do not include SSE. While lithium-metal batteries are capable of high energy densities, they are typically infeasible to use for fast charging because of the growth of dendrites. More particularly, fast charging can result in the rapid formation of dendrites, which can grow through or puncture porous SSE separators.

### High-Energy-Density Solid State Batteries

In various aspects, the present disclosure provides a composite electrode having high active material loading, high-energy-density lithium-ion and lithium-metal batteries including the composite electrode, methods of manufacturing the composite electrode, and methods of manufacturing electrode-separator laminates for the batteries. The composite electrodes may be manufactured in a hot-pressing or hot-rolling process that takes a sulfide or oxy-sulfide glass-containing SSE above its glass transition temperature to allow it to flow around the electroactive material particles. Thus, the composite electrode is densified or consolidated. The resulting consolidated/densified composite electrode has a low porosity and high active material content. A laminate for a lithium-ion battery can be formed by hot pressing a SSE separator between positive and negative composite electrodes. A laminate for a lithium-metal battery can be formed by hot pressing a SSE separator and a composite positive electrode, and then cold pressing a lithium-metal electrode to the separator opposite the composite positive electrode. In certain aspects, the composite electrodes and SSE are hot pressed (consolidated/densified) prior to hot pressing the laminate. In alternative aspects, the composite electrodes and/or SSE are placed in communication in a green state prior to consolidation/densification and hot pressing. Thus, the composite electrodes and/or SSE are consolidated/densified concurrently with forming the laminate.

Composite electrodes and batteries manufactured in accordance with certain aspects of the present disclosure offer several advantages. Bringing the SSE to its glass transition temperature during hot pressing allows it to flow around electroactive material particles (similar to liquid electrolyte in non-solid-state batteries). Thus, less SSE is needed to achieve a good interface between the SSE and the electroactive material. The resulting composite electrode has a low porosity (e.g., less than 10%, and in some variations less than 5%). Both the intimate contact between the electroactive material and the SSE, and the low porosity lead to high active material loading in the composite electrode.

Hot pressing can also be used to form dense separators that are resistant to dendrites, thereby improving the function of lithium-metal electrodes in all-solid-state batteries by increasing the current density and areal capacity while reducing the occurrence of shorting due to dendrite growth. The composite electrodes and dense separators can be hot pressed into electrode-separator laminates for high-energy-density batteries. For example, lithium-ion batteries may have energy densities ≥200 Wh/kg and be capable of fast charging, and lithium-metal batteries may have energy densities ≥400 Wh/kg. Finally, the high temperatures used in the hot pressing process facilitate the use of lower pressures that require less-complex equipment compared to cold pressing.

### Method of Making a Composite Electrode

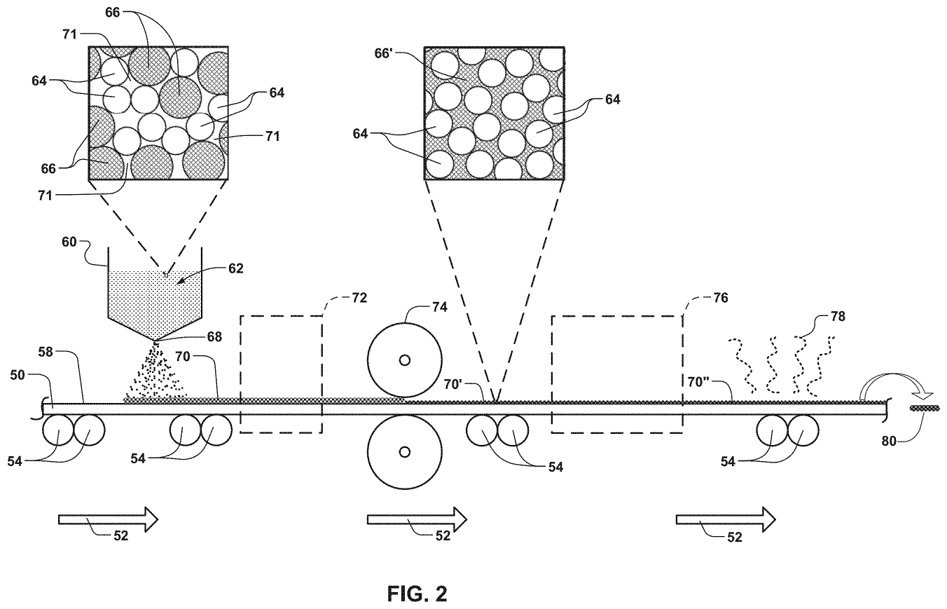

With reference to FIG. 2, a method of making a composite electrode according to certain aspects of the present disclosure is provided. A substrate 50 may be a portion of a continuous belt. The substrate 50 is carried in a direction of the arrows 52, for example by rollers 54, into a fabrication zone.

The substrate 50 may be subject to a range of temperatures that generally remain below about 350° C. The substrate 50 may be formed from a material that exhibits suitable structural strength at the temperatures of interest, and is non-reactive with the materials of the composite electrode to be formed (i.e., electroactive material, glass SSE, and optional conductive particles and/or reinforcement). Suitable substrate 50 materials can include quartz, borosilicate glass, stainless steels, other metals and alloys having melting points of >1,000° C., polytetrafluoroethylene (PTFE), and polyetherketone (PEEK). The substrate 50 may have a smooth surface 58.

As the substrate 50 advances, it may pass below a hopper 60. The hopper 60 may contain an admixture 62 of electroactive material particles 64 and sulfide or oxy-sulfide glass particles 66 (referred to as the “glass SSE particles”). The admixture 62 may optionally include conductive particles (e.g., carbon black particles), a reinforcement (e.g., glass fibers), and/or a conductive reinforcement (e.g., carbon fibers). The electroactive material particles 64 and the glass SSE particles 66 may each define a wide range of sizes to promote closer packing during subsequent compaction.

In various aspects, the reinforcement may be in the form of a mat rather than individual fibers. When the reinforcement is a mat, it is omitted from the admixture 62. Instead, the mat is fed, as needed, from a roll onto the substrate 50 to match the progress of the moving substrate 50. One suitable example of incorporating a mat reinforcement into a hot pressing process is described in U.S. patent application Ser. No. 15/631,261 (Filing Date: Jun. 23, 2017; Title: “Ionically-Conductive Reinforced Glass Ceramic Separators/Solid Electrolytes”; Inventors: Thomas A. Yersak and James Salvador), herein incorporated by reference in its entirety.

The hopper 60 may include a dispensing nozzle 68. The admixture 62 may be applied to the surface 58 of the substrate 50 by gravity through the nozzle 68 in a substantially uniform powder layer 70. Although a single hopper 60 having a single nozzle 68 is shown, one skilled in the art will appreciate that multiple hoppers 60 and/or multiple nozzles 68 may be used. Moreover, different or additional equipment can be used to apply the uniform power layer 70 to the substrate 50 and/or achieve a uniform distribution (e.g., screw conveyors, vibratory screens, doctor blade, vibratory exciter). In alternative aspects, the admixture 62 is applied to the substrate 50 as a paste containing a volatile solvent that may be evaporated after deposition, by spray deposition, by electrostatic deposition, or by any other suitable means known to those skilled in the art.

The powder layer 70 may continue moving in the direction of the arrow 52. The powder layer 70 may optionally be preheated in an oven or furnace 72 (shown in broken lines). The powder layer 70 may be heated to a preheat temperature in a range of about 50-450° C.

The powder layer 70 may be heated and compacted, for example by passing through one or more pairs of heated rollers 74 to form a compact 70′. This process is referred to as “hot pressing.” The powder layer 70 may be held at a compaction temperature and pressure for a predetermined duration to form the compact 70′. A suitable temperature-pressure-duration combination is dependent upon a viscosity of the glass SSE, which is ideally low enough for the glass SSE particles 66 to flow under pressure rather than fracturing. During this step, the glass SSE particles 66 become flowable glass 66′. The flowable glass 66′ can infiltrate void spaces 71 around the electroactive material particles 64 to improve interfacial contact between the glass 66′ and the electroactive material particles 64.

The compaction temperature may therefore be greater than or equal to a glass transition temperature (T_{g}) of the glass SSE. To maintain the glass SSE in a compactable but fully-amorphous state, the temperature may be less than a crystallization temperature (T_{c}) of the glass SSE. In various aspects, the compaction temperature is greater than or equal to T_{g} and less than T_{c}, optionally greater than or equal to (T_{g}+20° C.) to less than T_{C}. By way of example, some sulfide and oxy-sulfide glasses have a T_{g} of about 210-220° C. and a T_{C} of about 220-280° C. In the above case, the compaction temperature may be in a range of 210−280° C. The compaction pressure may be in a range of about 0.1-360 MPa. In one example the compaction pressure is in a range of about 0.1-10 MPa. In another example, the compaction pressure is in a range of about 10-360 MPa. The compaction duration may be in a range of about 1-3,600 seconds. In one example, the compaction duration is about 1-60 seconds. In another example, the compaction duration is about 60-3,600 seconds.

After compaction, the sulfide and oxy-sulfide glass 66′ in the compact may exhibit internal stresses that have the potential to promote spontaneous fracture and fragmentation. The compact 70′ may therefore optionally pass through an annealing furnace 76 (shown in skeleton) to relieve internal stresses and form an annealed compact 70″. Based on the annealing temperature selected, a microstructure of the glass SSE 66′ may either remain amorphous, or may be at least partially crystallized as described below. For retaining the fully amorphous microstructure, the annealing temperature may be in a range of about T_{g}−T_{c}. In general, shorter annealing durations are appropriate for higher annealing temperatures and longer annealing durations are appropriate for lower annealing temperatures. For a partially crystalline microstructure of the glass, the annealing temperature may be increased to above T_{c} for at least a portion of the annealing duration.

In certain aspects, it may be desirable for the microstructure of the glass to be at least partially crystalline. A partially crystalline microstructure includes isolated, discontinuous nanometer- or micrometer-sized crystalline regions surrounded by amorphous material. Partially crystalline microstructures may exhibit higher ionic conductivity and improved mechanical properties when compared to a fully-amorphous microstructure. In various aspects, the crystalline regions are discontinuous. A volume percent of the glass SSE 66′ that is crystalline may be in a range of about 1-60%, and optionally about 20-40%. An exemplary nucleation and growth process of crystallization is described in U.S. patent application Ser. No. 15/480,505 (Filing Date: Apr. 6, 2017; Title: “Sulfide and Oxy-Sulfide Glass and Glass-Ceramic Films for Batteries Incorporating Metallic Anodes”; Inventors: Thomas A. Yersak, James R. Salvador, and Han Nguyen), herein incorporated by reference in its entirety.

On exiting the annealing furnace 76, the annealed compact 70″ may slowly cool by radiation as indicated at 78. The annealed compact 70″ may be cooled to room temperature (i.e., about 20-25° C.). The annealed compact 70″ may then be removed from the substrate 50 to form the composite electrode material 80. The surface 58 of the substrate 50 does not react, bond, or otherwise engage with the annealed compact 70″. Therefore, the annealed compact 70″ can be readily separated from the substrate 50 without inducing deformation or other damage to either the annealed compact 70″ or the substrate 50.

The composite electrode material 80 may undergo further processing for use in a battery. For example, the composite electrode material 80 may be cut or otherwise fragmented into a plurality of discrete sheets suitably sized for the battery into which they are to be incorporated. The electrode material 80 may be used as-is after being cut. In alternative aspects, the composite electrode material 80 may be powderized and formed into an electrode according to standard film casting methods, such as cold pressing, tape casting, or forming with a binder. One suitable example of powderizing includes ball milling.

In an alternative aspect, the process of making a composite electrode material by hot pressing the admixture 62 is performed in batch mode. For example, a portion of the admixture 62 can be preheated and then confined between optionally-heated platens of a press or other pressure-inducing device and heated until a compact is formed. The compact may conform in size to the platen press. The compact may optionally be transferred to an oven for annealing. In another example, the entire press is contained within an oven and a temperature of the oven is adjusted appropriated for the particular process step (e.g., preheating, compacting, annealing).

### Composite Electrode

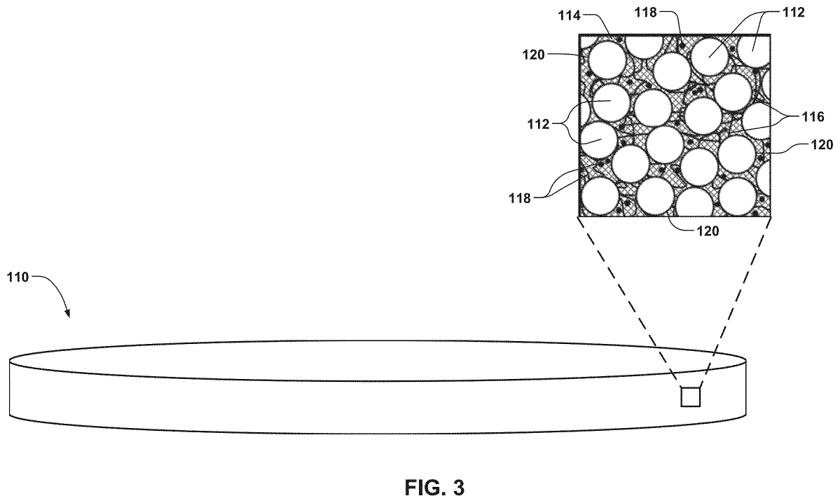

With reference to FIG. 3, a composite electrode 110 according to certain aspects of the present disclosure is provided. The composite electrode 110 includes electroactive material particles 112, a glass SSE 114, a reinforcement 116, and electrically-conductive particles 118. The glass SSE 114 may fill voids between the electroactive material particles 112 to facilitate a good interface between the electroactive material particles 112 and the glass SSE 114. In various aspects, the composite electrode 110 may omit the reinforcement 116 and the electrically-conductive particles 118.

The electroactive material particles 112 may include a positive electroactive material or a negative electroactive material, such as those described above. The glass SSE 114 may include a sulfide or oxy-sulfide glass, as described above. The electrically-conductive particles 118 may be similar to those described above.

The reinforcement 116 may be in the form of a plurality of individual chopped fibers, a non-woven fiber mat, a woven fiber mat, or a plurality of particles with a plate-like geometry. The reinforcement 116 may be selected from the group consisting of: a silica-based glass fiber, an alumina fiber, a boron nitride fiber, an exfoliated clay particle, a mineral particle, a thermoplastic polymer fiber, a carbon fiber, and combinations thereof. In various aspects, the reinforcement 116 is electrically conductive and the electrically-conductive particles 118 are omitted. Suitable electrically-conductive reinforcements include: carbon fibers, conductive polymer fibers, and metal fibers, by way of example.

As described above, the use of a hot pressing process to form the composite electrode 110 above T_{g} of the glass SSE facilitates a reduction in porosity and an improvement in contact between the electroactive material particles 112 and the glass SSE 114 compared to typical composite electrodes formed by cold pressing or with binders. In various aspects, the composite electrode 110 (e.g., the composite electrode material 80) may have a porosity of <10%, optionally ≤9%, optionally ≤8%, optionally ≤7%, optionally ≤6%, optionally ≤5%, optionally ≤4%, optionally ≤3%, optionally ≤2%, and optionally ≤1%. As used herein, the term “porosity” refers to the glass SSE 114 and interfaces between the glass SSW 114 and the electroactive material particles 112. Therefore, porosity does not take into account inherent porosity in the electroactive material particles 112. For example, silicon-containing electroactive material may have a porosity of about 50%. While the hot pressing process of the present disclosure may reduce or eliminate porosity of the glass SSE 114 and interfaces between the glass SSE 114 and the electroactive material particles 112, the reinforcement 116, and the electrically-conductive particles, the inherent porosity in the electroactive material particles 112 may remain. The inherent pores in the electroactive material particles 112 may be too small to be infiltrated by the glass SSE 114 during compaction.

Furthermore, the most or all of the outermost surfaces of the electroactive material particles 112 may be in direct physical contact with the glass SSE 114 (i.e., “coated” with SSE). As used herein, “coated” refers to a percentage of an outermost surface area 120 of each electroactive material particle 112 that is in direct physical contact with glass SSE. The term “outermost” excludes internal surfaces of the pores of the electroactive material particles 112. In various aspects, at least a portion of the electroactive material particles 112 are ≥70% coated with glass SSE 114, optionally ≥75%, optionally ≥80%, optionally ≥85%, optionally ≥90%, optionally ≥95%, optionally ≥97%, and optionally ≥99%.

When the electroactive material particles 112 include a positive electroactive material, the composite electrode 110 may have an active material loading of ≥60%, optionally ≥61%, optionally ≥62%, optionally ≥63%, optionally ≥64%, optionally ≥65%, optionally ≥66%, optionally ≥67%, optionally ≥68%, optionally ≥69%, and optionally ≥70%, where active material loading describes a mass percentage of electroactive material in the composite electrode 110. When the electroactive material particles 112 include a negative electroactive material, the composite electrode 110 may have an active material loading of ≥40%, optionally ≥42%, optionally ≥44%, optionally ≥46%, optionally ≥48%, optionally ≥50%, optionally ≥52%, optionally ≥54%, optionally ≥56%, optionally ≥58%, and optionally ≥60%.

### Method of Manufacturing a Laminate for a Lithium-Ion Battery

In various aspects, the present disclosure provides a method of manufacturing a laminate for a lithium-ion battery. With reference to FIG. 4, at 130, the method includes forming a pre-laminate by disposing a separator composition between a positive composite electrode composition and a negative composite electrode composition. In one aspect, the positive and negative electrode compositions are consolidated/densified composite electrodes formed by hot pressing, such as those described above, and the separator is a consolidated/densified separator. Two suitable examples of the separator are described in U.S. patent application Ser. Nos. 15/480,505 and 15/631,261, cited above. In another aspect, the positive and negative composite electrode compositions and the separator composition are in a green state such that they are not yet consolidated/densified. In the green state, the positive electrode composition includes at least a positive electroactive material and a glass SSE, the negative electrode composition includes at least a negative electroactive material and a glass SSE, and the separator composition includes at least a glass SSE. In this case, disposing the separator composition between the positive and negative composite electrode compositions may include preparing the three distinct powder layers, one on top of another. The glass SSEs in the positive composite electrode composition, the negative composite electrode composition, and the separator composition may be the same or they may be different.

At 132, the pre-laminate may be heated to a temperature. The temperature may be greater than or equal to T_{g} and less than T_{c}. T_{g} is the highest glass transition temperature of the glass SSE of the positive composite electrode composition, the glass SSE of the negative composite electrode composition, and the glass SSE of the separator composition. T_{c} is the lowest crystallization temperature of the glass SSE of the positive composite electrode composition, the glass SSE of the negative composite electrode composition, and the glass SSE of the separator composition. The temperature may be in a range of about 50-400° C. In one aspect, the temperature is about 50-150° C. In another aspect, the temperature is about 150-250° C. In yet another aspect, the temperature is about 250-400° C. At 134, the method may include applying pressure to the pre-laminate to form the laminate for the lithium-ion battery. The application of pressure facilitates the flow of the glass SSE to increase direct surface contact at a positive electrode-separator interface and at a negative electrode-separator interface where the electrode and separator compositions are pre-consolidated/densified. Where the electrode and separator compositions are in the green state, the application of pressure facilitates the flow of the glass SSE to both infiltrate spaces between the electroactive material particles and increase direct surface contact at interfaces between the electrode and separator compositions. Thus, when the electrode and separator compositions are in the green state, the application of temperature and pressure concurrently forms the consolidated/densified electrodes and separator and the laminate. The pressure may be in a range of about 0.1-360 MPa. In one aspect, the pressure is about 0.1-10 MPa. In another aspect, the pressure is about 10-360 MPa. The pressure may be applied for a duration of about 1-3,600 seconds.

Although the heating and the applying pressure are shown separately at steps 132 and 134, respectively, they may alternatively be performed concurrently. Furthermore, the method may include more than one heating step. In one alternative example, the pre-laminate is preheated, and then subjected to concurrently-applied heat and pressure. In another example, the pre-laminate is placed directly into a heated press and the heating and pressing occur concurrently. In various aspects, the positive composite electrode composition and the negative composite electrode composition could be joined to the separator composition in separate processes.

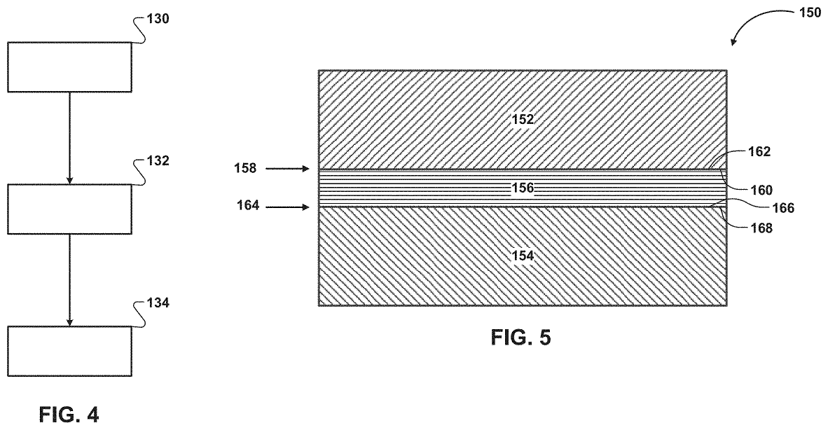

With reference to FIG. 5, an example laminate 150 is shown. The laminate 150 includes a positive electrode 152, a negative electrode 154, and a separator 156. A first interface 158 defines direct contact between a surface 160 of the positive electrode 152 and a first surface 162 of the separator 156. A second interface 164 defines direct contact between a surface 166 of the negative electrode 154 and a second surface 168 of the separator 156. In various aspects, at least a portion of an area of the surface 160 of the positive electrode 152 may be in direct contact with the first surface 162 of the separator 156, where the portion is ≥70%, optionally ≥_80%, and optionally ≥_90%. At least a portion of an area of the surface 166 of the negative electrode 154 may be in direct contact with the second surface 168 of the separator 156, where the portion is ≥70%, optionally ≥80%, and optionally ≥90%. In general, a larger portion leads to a lower impedance of the interface. A perfect interface would have an impedance of 0 Ω/cm, representing 100% contact (i.e., portion=100%). Each of the first and second interfaces 158, 164 may have an impedance <10 Ω/cm², optionally <5 Ω/cm², and optionally <1 Ω/cm².

Each of the positive electrode 152, the negative electrode 154, and the separator 156 may have a low porosity, as generally described above. The positive and negative electrodes 152, 154 may have active material loading, as described above. As a result of the low porosity and high active material loading, the laminate 150 may have a high energy density. In various aspects, the energy density is ≥200 Wh/kg, optionally ≥210 Wh/kg, optionally ≥220 Wh/kg, and optionally about 230 Wh/kg.

### Method of Manufacturing a Laminate for a Lithium-Metal Battery

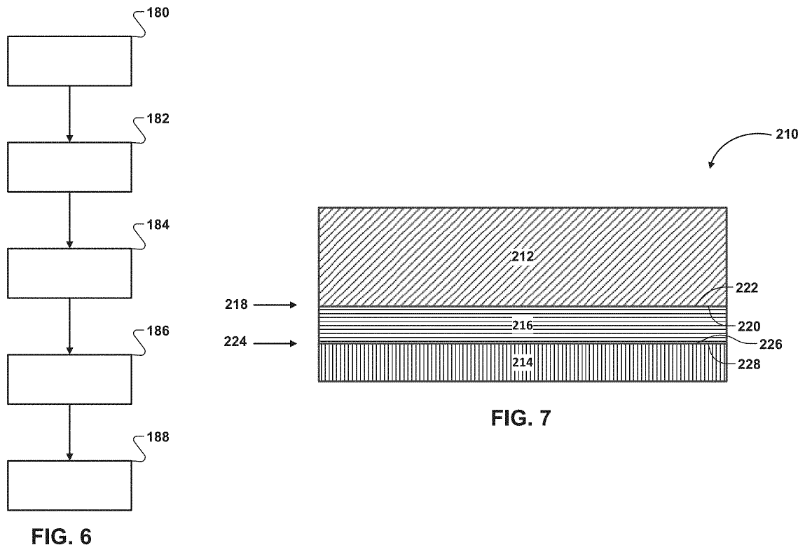

In various aspects, the present disclosure provides a method of manufacturing a laminate for a lithium-metal battery. Referring to FIG. 6, at 180, the method includes forming a pre-laminate by placing a positive composite electrode composition and a separator composition in direct physical contact. As described above, the positive composite electrode and separator compositions may be in either a consolidated/densified state or in a green state.

At 182, the pre-laminate may be heated to a temperature. The temperature may be greater than or equal T_{g} (i.e., a highest glass transition temperature of a glass SSE of the positive composite electrode composition and a glass SSE of the separator composition) and less than T_{c} (i.e., a lowest crystallization temperature of the glass SSE of the positive composite electrode composition and the glass SSE of the separator composition). The temperature may be in a range of about 50-400° C. In one aspect, the temperature is about 50-150° C. In another aspect, the temperature is about 150-250° C. In yet another aspect, the temperature is about 250-400° C. At 184, the method may include applying pressure to the pre-laminate. The pressure may be in a range of about 0.1-360 MPa. In one aspect, the pressure is about 0.1-10 MPa. In another aspect, the pressure is about 10-360 MPa. The pressure may be applied for a duration of about 1-3,600 seconds. Similar to the process described above, the steps of heating and applying pressure may alternatively be performed concurrently and/or the method may further include a preheating step.

At 186, a negative electrode is placed in direct physical contact with the separator to form an intermediate-laminate. More particularly, the intermediate laminate includes the separator composition that is disposed between the positive composite electrode composition and the negative electrode. The negative electrode includes lithium metal. At 188, pressure is applied to the intermediate-laminate to form a laminate for a lithium metal. The pressure may be in a range of about 0.1-360 MPa. In one aspect, the pressure is about 0.1-10 MPa. In another aspect, the pressure is about 10-360 MPa. The pressure may be applied for a duration of about 1-3,600 seconds. In one aspect, the duration is about 1-60 seconds. In another aspect, the duration is about 60-3,600 seconds. The pressure may be applied at room temperature (i.e., about 20-25° C.). However, the intermediate-laminate may optionally be heated while pressure is applied. The intermediate-laminate may be heated to a temperature in a range of about 0-180° C. In one aspect, the temperature is about 0-60° C. In another aspect, the temperature is about 60-180° C.

In alternative aspects, another electrolyte is disposed between the intermediate laminate and the lithium metal negative electrode. The other electrolyte may be a non-glass electrolyte, such as a liquid electrolyte, a gel electrolyte, or a polymer electrolyte. In the case of the liquid or gel electrolyte, wettability at an interface between the separator composition and the other electrolyte and an interface between the other electrolyte and the lithium metal negative electrode may be high enough that the pressing or rolling operation can be omitted. In the case of a polymer electrolyte, another pressing operation may be used to increase communication between the polymer electrolyte and the separator composition and the lithium metal electrode. A pressure may be about 0.1-10 MPa. A temperature may be about 20-100° C.

With reference to FIG. 7, an example laminate 210 is shown. The laminate includes a positive electrode 212, a negative electrode 214, and a separator 216. The negative electrode 214 may include lithium metal. A first interface 218 defines direct contact between a surface 220 of the positive electrode 212 and a first surface 222 of the separator 216. A second interface 224 defines direct contact between a surface 226 of the negative electrode 214 and a second surface 228 of the separator 216.

In alternative aspects, another electrolyte may be disposed between the negative electrode 214 and the separator 216 (not shown). Therefore, the negative electrode 214 may be in communication with the separator 216, but not in direct contact with the separator 216. The other electrolyte may be in the form of a liquid, a gel, or a polymer.

The positive electrode 212 and the separator 216 may have low porosity. The positive electrode 212 and the negative electrode 214 may have high active material loading. Active material loading of the positive electrode may be similar to the values described above. Active material loading of the negative electrode may be 100% when it is formed from lithium metal. As a result of the low porosity and high active material loading, the laminate 210 may have a high energy density. In various aspects, the energy density is ≥200 Wh/kg, optionally ≥300 Wh/kg, and optionally ≥400 Wh/kg. In various aspects, the hot pressed separator may be extremely dense and resistant to penetration dendrites. Accordingly, the hot pressing formation process may be particularly useful for lithium-metal batteries.

### Example

A composite compact 240 is prepared according to certain aspects of the present disclosure. The composite compact is formed in a batch process. An admixture is prepared from Toray carbon fiber paper reinforcement and powderized 70Li₂S-25P₂S₅-5P₂O₅, an oxy-sulfide glass. The admixture is heated to a compaction temperature of about 235° C. and compressed to a compaction pressure of about 7-14 MPa. The admixture is held at the compaction temperature and pressure for about 3,600 seconds to form the compact. The compact is cooled by radiation.

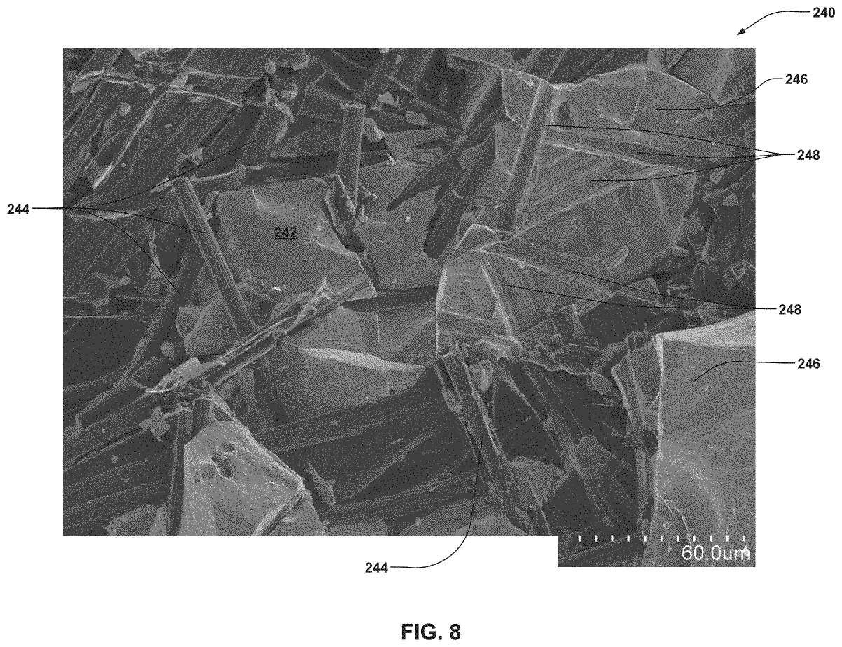

FIG. 8 is a scanning electron microscope (SEM) image of a fracture surface 242 of the compact 240. The compact 240 includes carbon fibers 244 within glass SSE 246. At the compaction temperature, the glass SSE 246 is above its glass transition temperature and is therefore able to flow around the carbon fibers 244, reducing or eliminating porosity. Once the compact is cooled, the carbon fibers 244 remain embedded in the glass SSE 246. When the fracture surface 242 is formed, some of the carbon fibers 244 break away to leave imprints 248 in the fracture surface 242. The imprints 248 are sized and shaped to match the respective carbon fibers 244. Other carbon fibers 244 stick out from the fracture surface 242 where glass SSE 246 has been broken away. The composite 240 has minimal to no porosity.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of fabricating a composite electrode for use in an electrochemical cell, the method comprising:
preparing a layer of powder comprising a plurality of electroactive material particles and a plurality of electrolyte particles, the electrolyte particles comprising a sulfide or oxy-sulfide glass;
heating the layer of powder to a temperature of greater than or equal to T_{g} and less than T_{c}, where T_{g} is a glass transition temperature of the sulfide or oxy-sulfide glass and T_{c} is a crystallization temperature of the sulfide or oxy-sulfide glass; and
while the sulfide or oxy-sulfide glass electrolyte is at the temperature, applying a pressure of about 0.1-360 MPa to the layer of powder, wherein the pressure causes the sulfide or oxy-sulfide glass to flow around the electroactive material particles to create a compact.

2. The method of claim 1, wherein the pressure is about 0.1-10 MPa.

3. The method of claim 1, wherein the pressure is applied for about 1-3,600 seconds.

4. The method of claim 1, wherein the compact has a porosity of ≤5%.

5. The method of claim 1, wherein the layer of powder further incorporates at least one of:
a plurality of electrically-conductive particles; and
a reinforcement in a form of: a plurality of individual chopped fibers, a non-woven fiber mat, a woven fiber mat, or a plurality of particles with a plate-like geometry.

6. The method of claim 1, further comprising:
powderizing the compact to create a plurality of electrolyte-coated electroactive material particles; and
film casting an admixture comprising the plurality of electrolyte-coated electroactive material particles to form the composite electrode.

7. A method of fabricating an electrode-separator laminate for an electrochemical cell, the method comprising:
forming a pre-laminate by placing a composite electrode composition and a separator composition in direct physical contact, the composite electrode composition comprising an electroactive material and an electrolyte comprising a sulfide or oxy-sulfide glass, and the separator composition comprising an electrolyte comprising another sulfide or oxy-sulfide glass and being ionically conductive and electrically insulating;
heating the pre-laminate to a temperature of greater than or equal to T_{g} and less than T_{c}, where T_{g} is a highest glass transition temperature of the sulfide or oxy-sulfide glasses and T_{c} is a lowest crystallization temperature of the sulfide or oxy-sulfide glasses; and
applying pressure to compress the pre-laminate, the pressure being about 0.1-360 MPa.

8. The method of claim 7, wherein the pressure is applied for about 1-3,600 seconds.

9. The method of claim 7, wherein the separator composition includes a different sulfide or oxy-sulfide glass than the composite electrode composition.

10. The method of claim 7, wherein the forming the pre-laminate further comprises placing the separator composition in direct physical contact with another composite electrode composition such that the separator composition is disposed between the composite electrode compositions, one of the composite electrode compositions comprising a positive electroactive material and the other of the composite electrode compositions comprising a negative electroactive material.

11. The method of claim 7, further comprising:
after the heating the pre-laminate, placing a lithium-metal electrode in communication with the separator composition to form an intermediate-laminate such that the separator composition is disposed between the composite electrode composition and the lithium-metal electrode; and
applying pressure to compress the intermediate-laminate, wherein the pressure is about 0.1-360 MPa.

12. The method of claim 11, wherein the applying pressure to compress the intermediate-laminate is performed at a temperature of about 0-180° C.

13. The method of claim 7, further comprising after the heating the pre-laminate, disposing another electrolyte between the separator composition and a lithium-metal electrode, wherein the other electrolyte comprises a liquid electrolyte, a gel electrolyte, or a polymer electrolyte.

14. A composite electrode for use in an electrochemical cell, the composite electrode comprising:
an electroactive material; and
a solid electrolyte comprising a sulfide or oxy-sulfide glass, wherein a mass percentage of electroactive material in the composite electrode is ≥50% and the composite electrode has a porosity of ≤5%.

15. The composite electrode of claim 14, wherein the electroactive material is in a form of a plurality of particles, each particle having an outermost surface area that is at least 75% coated by the solid electrolyte.

16. The composite electrode of claim 14, further comprising an electrically-conductive particle.

17. The composite electrode of claim 14, further comprising a reinforcement in a form of a plurality of individual chopped fibers, a non-woven fiber mat, a woven fiber mat, or a plurality of particles with a plate-like geometry, wherein the reinforcement is selected from the group consisting of: a silica-based glass fiber, an alumina fiber, a boron nitride fiber, an exfoliated clay particle, a mineral particle, a thermoplastic polymer fiber, a carbon fiber, a conductive polymer fiber, a metal fiber, and combinations thereof.

18. The composite electrode of claim 14, wherein the electroactive material is a positive electroactive material and the mass percentage is ≥65%.

19. The composite electrode of claim 14, wherein the electroactive material is a negative electroactive material and the mass percentage is ≥55%.

20. The composite electrode of claim 14, wherein the porosity is ≤3%.
